(19) United States
(12) Patent Application Publication
(10) Pub. No.: US 2014/0137418 A1
(43) Pub. Date: May 22, 2014

(54) TRIMMER IMPROVER

(71) Applicant: SHIN-SHI PLASTIC MOLD INDUSTRIAL, CO., LTD., NEW TAIPEI CITY (TW)

(72) Inventor: FU-JEN ZHU, NEW TAIPEI CITY (TW)

(73) Assignee: SHIN-SHI PLASTIC MOLD INDUSTRIAL, CO., LTD., NEW TAIPEI CITY (TW)

(21) Appl. No.: 14/071,671

(22) Filed: Nov. 5, 2013

(30) Foreign Application Priority Data
Nov. 22, 2012 (TW) 101222661
Jul. 25, 2013 (TW) 102214040

(51) Int. Cl. B26D 7/26

(52) U.S. Cl. CPC B26D 7/26
USPC 30/286

(57) ABSTRACT

A trimmer improver comprises: a blade holder, of which one side is formed with a guide groove and at least one blade groove that aligns with the guide groove; at least one blade, being detachably and correspondingly arranged in the blade groove, of which the end is exposed to the blade groove; and a cover, of which the outer margin aligns with the upper edge of at least one blade groove to close the blade holder. Accordingly, with various types of blades replaceable, the trimmer improver is provided for much more effectively trimming the skins of the wood product made of different materials.

### (a) TECHNICAL FIELD OF THE INVENTION

This invention relates to a trimmer improver and particularly to a trimmer improver available for woodworkers or interior decorators.

### (b) DESCRIPTION OF THE PRIOR ART

Generally, after a wood product is completely made, more or less rough edges are formed on the wood product or sharp corners are formed; to avoid the rough edges from being formed or the sharp corner from making someone hurt, during wood processing, the rough edges and the sharp corners must be thus trimmed. Further, for the nice touch on and good look of the wood product, wooden decorations are added to the surface of wood product; accordingly, the trimmer is needed for cutting and trimming.

However, the conventional trimmer tool is mostly formed with a metal trimmer bed and a blade edge in one or formed with metal blades that are separately arranged at upper and lower ends, which is disadvantageous because the angle an direction of the blade edge do not help to overcome the problem of rough edges or fiber rips of the wood that is caused when the edges of wood skin of which the texture is irregular are trimmed and because the blade easily becomes blunt and gets rusty if being used for a long time. At this time, the entire trimmer mostly must be replaced, which increasingly causes the problem of environment protection. Moreover, the hardness levels of the wood products made of different materials of wood are different, so using only one type of metal blade for cutting does not help very much.

Consequently, because of the technical defects described above, to provide the trimmer improver of which various types of blades are replaceable for much more effectively trimming the skins of the wood product made of different materials, the applicant, based on many years of research and experience in the relevant industry has developed the present invention, which may effectively improve the defects described above.

### SUMMARY OF THE INVENTION

It is a main object of this invention to provide a trimmer improver of which various types of blades are replaceable for much more effectively trimming the skins of the wood product made of different materials.

In order to achieve the objective mentioned above, the trimmer improver according to this invention comprises: a blade holder, of which one side is formed with a guide groove and at least one blade groove that aligns with the guide groove; at least one blade, being detachably and correspondingly arranged in the blade groove, of which the end is exposed to the blade groove; and a cover, of which the outer margin aligns with the upper edge of at least one blade groove to close the blade holder.

In the trimmer improver, the end of the blade is formed with a one-way serrated edge or a single-side edge sharpening portion.

In the trimmer improver, the blade holder and the cover are further formed with a plurality of screw holes and are thereby fixed with screws.

In the trimmer improver, the blade holder is made of plastics, metal, or hard wood.

In the trimmer improver, the cover may be made of plastics, metal, or hard wood.

In the trimmer improver, the blade holder secures the blade with predefined screw holes and screws.

In the trimmer improver, at least one blade groove is made to pass through the guide groove.

In the trimmer improver, the end of at least one blade may be formed with a one-way serrated edge or a single-side edge sharpening portion.

Compared with the prior art, the trimmer improver according to this invention has the following advantages:
1. the trimmer improver is provided with various types of blades replaceable for much more effectively trimming the skins of the wood product made of different materials; and
2. with the blades replaceable, the problem of rough edges or fiber rips of the wood that is caused is solved when the edges of wood skin of which the texture is irregular are trimmed, and even when the blade becomes blunt or gets rusty, if being used for a long time, the blade is just replaced without need of replacement of the entire trimming tool set.

### BRIEF DESCRIPTION OF THE DRAWINGS

FIG. 1 is an exploded view of a trimmer improver according to this invention.

FIG. 2 is a 3D view of the trimmer improver according to this invention.

FIG. 3 is a schematic view illustrating various types of blades of the trimmer improver according to this invention.

FIG. 4 is a sectional view of a first embodiment of this invention.

FIG. 5 is a sectional view of a second embodiment of this invention.

FIG. 6 is a sectional view of a third embodiment of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

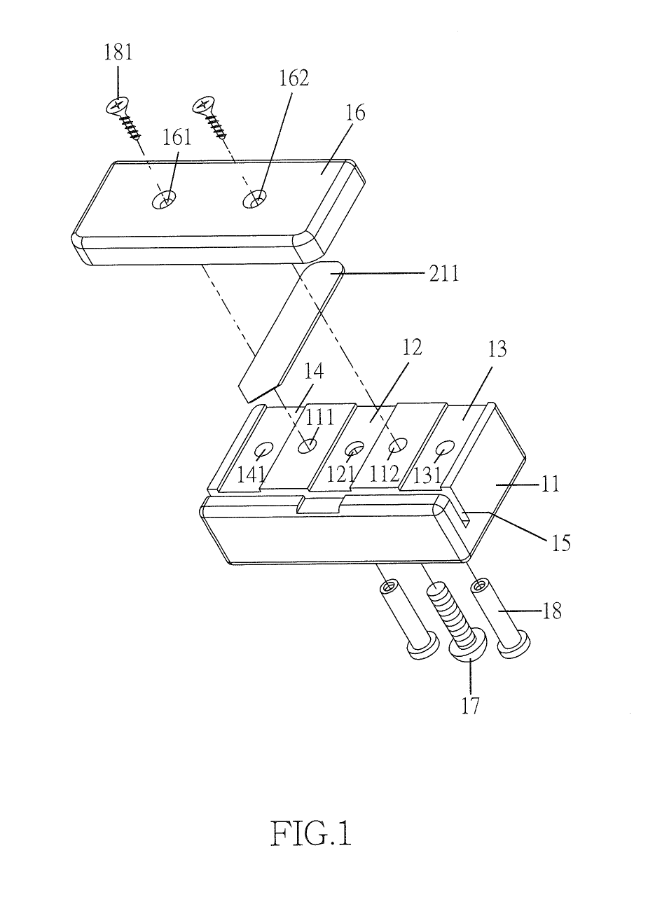

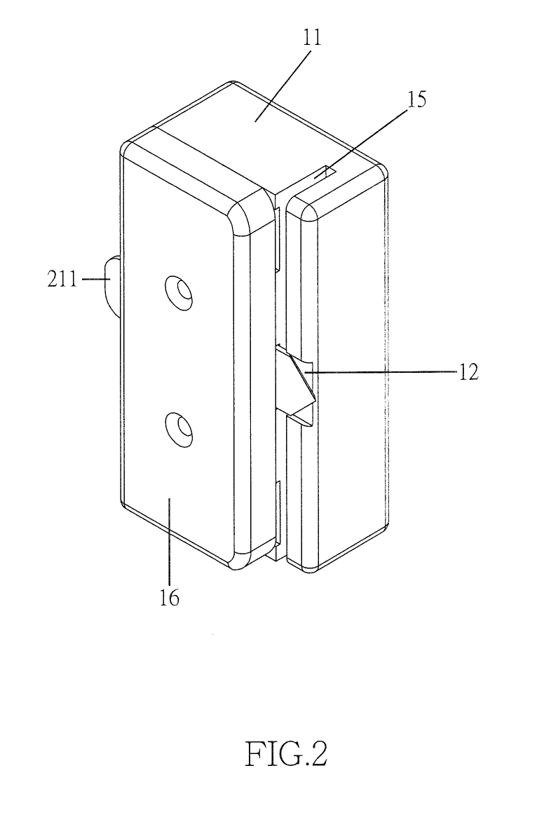

With reference to FIGS. 1, 2, and 3, a trimmer improver according to this invention comprises a blade holder 11, at least one blade 21, 31, or 41, and a cover 16. One side of the blade holder 11 is formed with a guide groove 15 and at least one blade groove. In this embodiment, three blade grooves, namely first blade groove 12, second blade groove 13, and third blade groove 14, are formed. The first blade slot 12 is made to pass through the guide groove 15, and the first blade groove 12, the second blade groove 13, and the third blade groove 14 are further formed respectively with one clamping hole 121, 131, and 141, each of which is formed with one clamping screw 17. The blade is detachably and correspondingly arranged in the blade groove. With the outer margin aligning with the lower edge of the guide groove 15, the cover 16 is made to close the blade holder 11. The blade holder 11 and the cover 16 are further formed respectively with a plurality of coupling holes 111, 112, 161, and 162, and the blade holder 11 is assembled with the cover 16 by inserting coupling parts into the coupling holes 111, 112, 161, and 162. In this embodiment, the coupling parts are a coupling stud 18 and a coupling screw 181. The blade holder 11 and the cover 16 are made of plastics, metal, or hard wood.

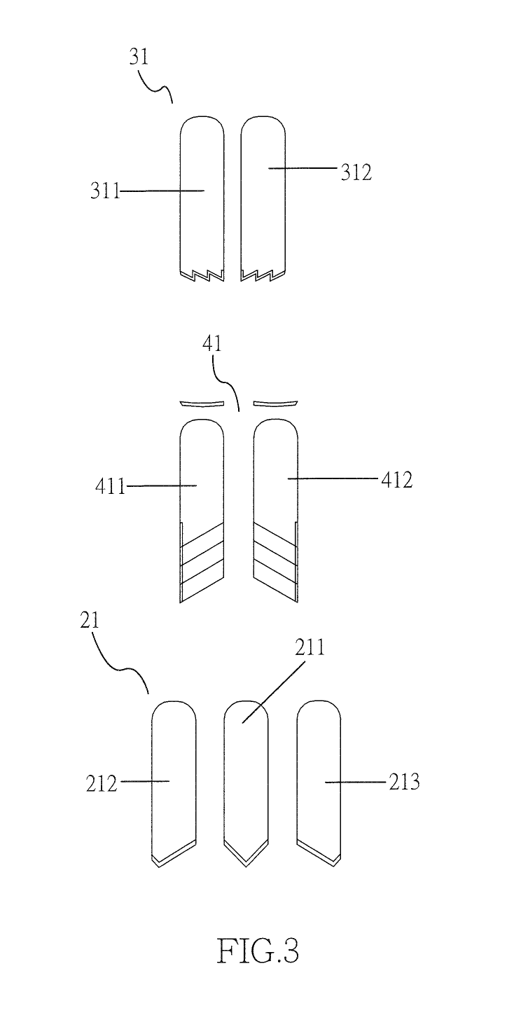

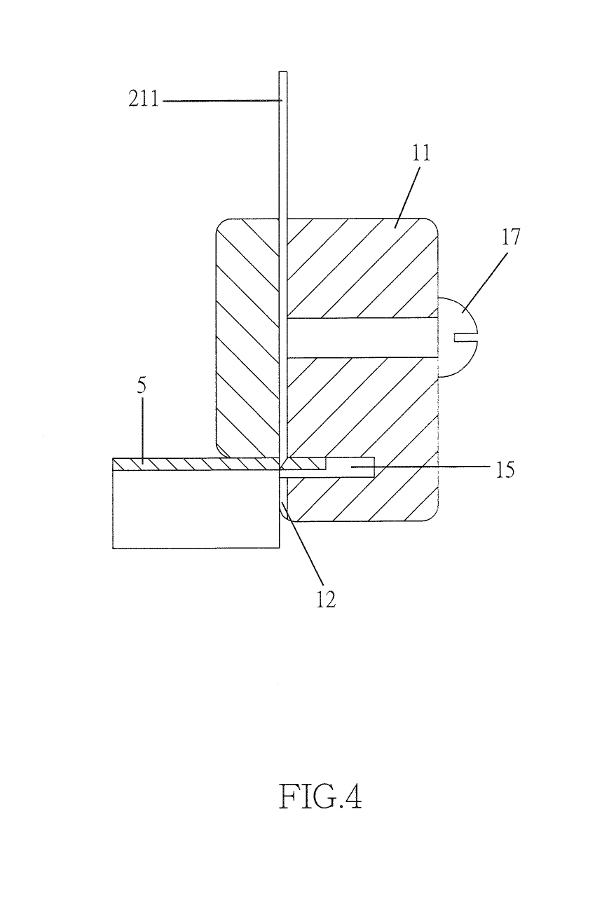

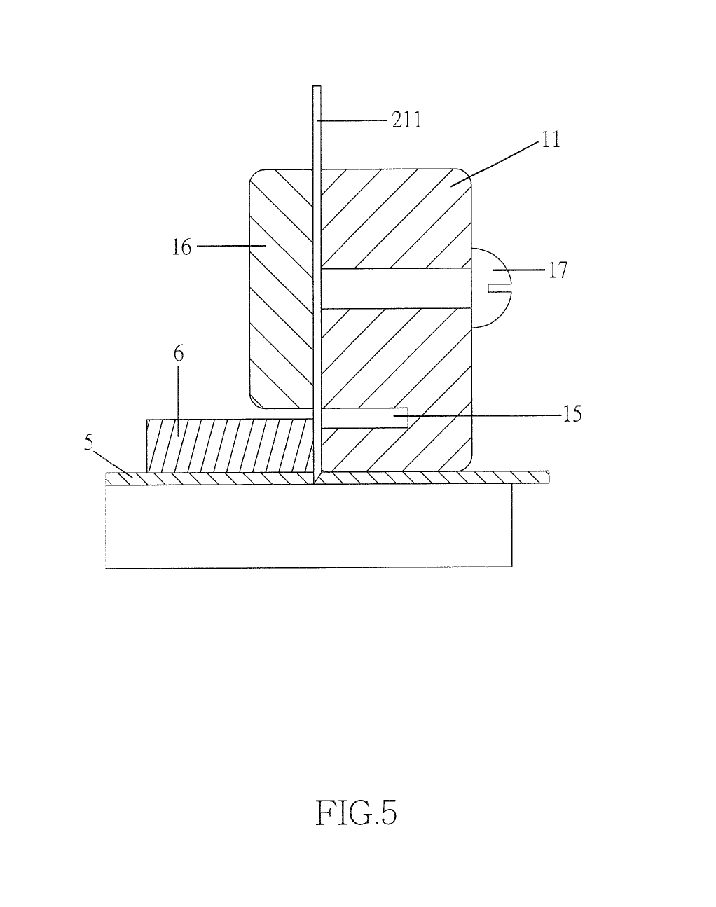

Further, with reference to FIG. 3, the blade according to this invention is classified into a pair of left and right cutting blades 31 exclusive for melamine board, into a pair of left and right planing blades 41 exclusive for melamine board, and into blades 21 exclusive for decorating skin. The body of planing blade 41 exclusive for melamine board is arc, and one end of the blade is sharp and may be broken for subsequent use when being blunt. 1˜3 blades 21 exclusive for decorating skin are provided for one group, in which the cutting edges of the left and right blade are respectively to the left and to the right for being much adjacent to the edge of a product, and the single-edge blade 211 exclusive for decorating skin is set into the first blade groove 12 of the blade holder 11, and the clamping screw 17 is used to adjust the position of the single-edge blade 211. As shown in FIG. 4, the single-edge blade 211 of which the blade tip is inserted into the guide groove 15 is used to cut a wood skin or decorate skin 5 of which the thickness is within 2 mm for edge trimming. Further, the clamping screw 17 is used again to adjust the position of the single-edge blade 211. As shown in FIG. 5, the tip of the single-edge blade 211 is made to pass through the guide groove 15 and downwards stretch to the bottom of the protruding blade holder 11 for working with a strip of plank as a presser foot to cut a strip of decorate skin 5 that will be used as a decorate patch or in another field.

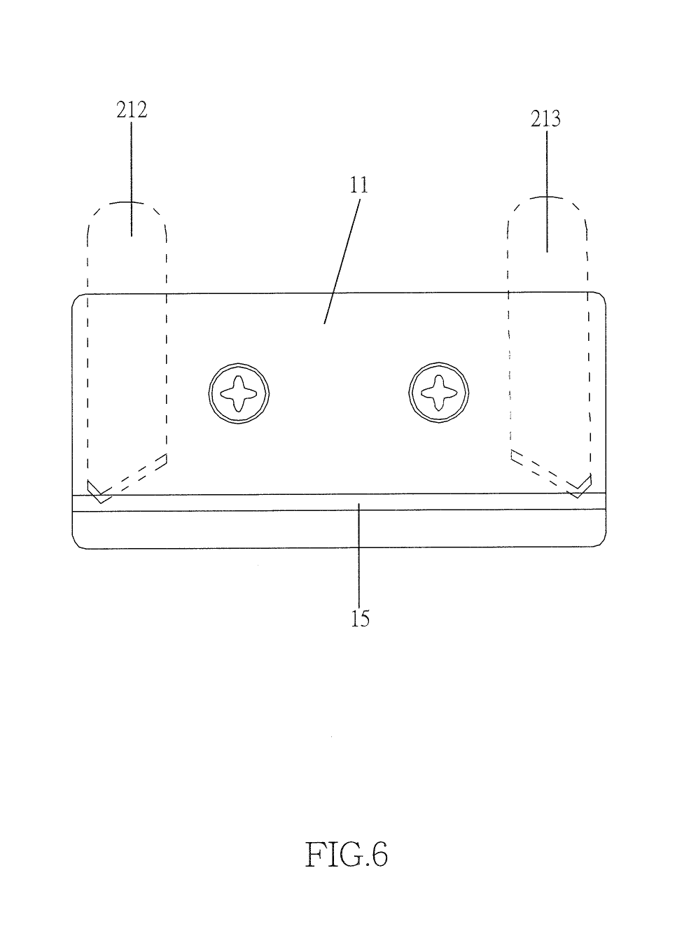

With reference to FIG. 6, the left-edge and right-edge blades 212 and 213 may be arranged respectively in the third blade groove 14 and the second blade groove 13. The clamping screws 17 are used to adjust the positions of the tips of the left-edge and right-edge 213 blades. The tips of the left-edge and right-edge blades 212 and 213 are arranged in the guide groove 15. Accordingly, the edge of the wood product is thereby closer to the tips of left-edge and right-edge blades for precisely trimming the edge of corner of the wood product.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

I claim:

1. A trimmer improver, comprising:
a blade holder, of which one side is formed with a guide groove and at least one blade groove that aligns with the guide groove;
at least one blade, being detachably and correspondingly arranged in the blade groove, of which the end is exposed to the lower portion of the blade groove; and
a cover, of which the outer margin aligns with the lower edge of at least one blade groove to close the blade holder.

2. The trimmer improver according to claim 1, wherein at least one to three pieces of blades of which the sets of cutting thickness are adjusted and exclusive for 2 mm decorating skins are provided for one group, left and right planing blades of which the body is arc exclusive for melamine board are provided for one group, or left and right cutting blades for melamine board is provided for one group.

3. The trimmer improver according to claim 1, wherein the blade holder and the cover are further formed with a plurality of coupling holes corresponding to each other and are thereby fixed with coupling studs and coupling screws.

4. The trimmer improver according to claim 1, wherein the blade holder is made of plastics, metal, or hard wood.

5. The trimmer improver according to claim 1, wherein the cover is made of plastics, metal, or hard wood.

6. The trimmer improver according to claim 1, wherein the blade holder secures the blade with predefined screw holes and screws.

7. The trimmer improver according to claim 1, wherein at least one blade groove is made to pass through the guide groove.

8. The trimmer improver according to claim 1, wherein the end of at least one blade is formed with a one-way serrated edge or a single-side edge sharpening portion.
